(19) United States
(12) Patent Application Publication
(10) Pub. No.: US 2022/0026946 A1
(43) Pub. Date: Jan. 27, 2022

(54) WEARABLE DEVICE

(71) Applicant: Kuei Ann WEN, Hsinchu County (TW)

(72) Inventor: Kuei Ann WEN, Hsinchu County (TW)

(21) Appl. No.: 17/008,780

(22) Filed: Sep. 1, 2020

(51) Int. Cl. G06F 1/16; G01P 13/00

(52) U.S. Cl. CPC G06F 1/163; G01P 13/00

(57) ABSTRACT

The present invention provides a wearable device comprising a housing and at least one indicator signal provided on the housing. The housing comprises a contact surface and a front surface opposite to the contact surface; the two are connected by a first side. The indicator surface of the signal is provided on the first side and extends to the contact surface and/or the front surface. The indicator signal surface may also be provided on a junction of the first side surface and a second side with the contact and the front surfaces.

### TECHNICAL FIELD The present invention relates to a wearable device, in particular to a general-purposed wearable device that is not limited to a specific purpose.

### BACKGROUND OF THE INVENTION

Wearable devices generally refer to electronic devices worn on people, animals, and other moving objects, especially to electronic devices worn on people. Such electronic devices usually have detection capabilities, i.e., to detect changes in the environment and to record such changes. The wearable device requires electrical power to support the continued operation of the device during the movement of the moveable objects. The records obtained during the operation can be sent to a computer device or even a cloud computer in real time or at a later time for further processing and applications.

Some wearable devices are equipped with image display devices for users to watch while moving. However, there are many wearable devices that do not need to provide a display device, but only a signaling device, such as an indicator signal. An indicator to display signals could be an LED lamp, because an LED lamp does not only provide a reduced size but can also be designed into various desired shapes. The indicator signal can be installed on the wearable device, where the user can easily see it. The so-called easy-to-see mainly means that the indicator displayed by the wearable device during its operation can be easily seen by the user, when the user is moving. Suppliers of various wearable devices can usually determine a location that the user can easily see during operation, according to the specific purpose of a specific wearable device, and configure the device to display a signal at that location. Recently, general-purpose wearable devices are popular in the market. This wearable device is not designed to provide a specific purpose, but can be designed, changed or set by the user to provide functions that the wearable device itself does not have before such design, change or setting.

Since at the time when a general-purposed device is design, the possible usages of the user at a later time cannot be predicted, where the display signal should be arranged has become a problem.

U.S. Pat. No. 10,456,623 B2 discloses a “Wearable device assembly having athletic functionality and milestone tracking,” a wearable device assembly having athletic functions and milestone tracking functions. The bracelet-shaped wearable device provides a light-emitting element 160, which is arranged on the bracelet, at the edge of the display device.

U.S. Pat. No. 10,218,884 B2 discloses an “Infrared video display eyewear,” infrared image display glasses that provide two sets of light-emitting arrays 130C for illumination, which are arranged at the upper edge of the frame of the glasses. U.S. Pat. No. 10,324,492 B2 discloses a “Smartphone with front camera and maximized display screen,” a smartphone with a camera and a maximized display screen on the front. The front of the phone provides both a display screen and a camera, and the camera's light source and detection window are both arranged on the front, at its corners.

It is known from the search results of the prior art that where the display signal of the wearable device should be located is a technical problem that the industry urgently needs to solve. For wearable devices with known uses or specific uses, designers can easily decide where to display the signal. For wearable devices with undetermined or wide-ranging uses, there are no known technology to address this issue.

### Objectives of the Invention

The purpose of the present invention is to provide a novel wearable device that provides a display signal, which is visible from almost all aspects, no matter where it is worn when in operations for respective purposes.

The object of the present invention is also to provide a novel structure of a wearable device. The housing of the wearable device is equipped with a display signal, and the display signal provides excellent visibility.

### SUMMARY OF THE INVENTION

According to the first aspect of the present invention, a wearable device is provided. The wearable device comprises a housing and a sensing device and a processing device, with at least a part of the sensing device and/or the processing device being enclosed in the housing. The sensing device detects its own movement and outputs a sensing signal, and the processing device receives the sensing signal and converts the sensing signal into sensing values.

The housing provides a contact surface and a front surface opposite to the contact surface, and the two are connected by a first side. The housing is provided at least one signal indicator, the signal indicator can be a light source and a display panel receives and propagates lights generated by the light source. The display surface of the signal light or the display panel is disposed on the first side and extend to a level at least substantially flush with the contact surface and the front surface;

The wearable device further comprises a power device for supplying power to the sensing device, the processing device and the signal indicator.

The extension of the display surface/panel may also exceed the contact surface and/or the front surface, therefore protrude beyond the contact surface and/or the front surface.

In a specific embodiment of the present invention, the contact surface and the front surface are connected by a first side and a second side, and the first side and the second side form an angle. In such embodiments, the signal indicator can be arranged at the junction of the first side and the second side, that is, the junction of the first side and the second side with the contact surface and the front surface.

According to another aspect, the present invention provides a wearable device. The invented wearable device comprises a housing and a switch arranged on the housing. The switch may be a push-push button. The housing provides a contact surface and a front surface opposite to the contact surface, and the two are connected by a first side. The switch is disposed on the first side, with the top surface of the switch at a distance away from the plane of the first side when raised, whereby the top surface is visible to a user when viewing directing to the contacting surface and/or the front surface.

In some preferred embodiments of the present invention, the contact surface and the front surface may be connected by a first side and a second side, and the first side and the second side form an angle. The switch may be located at the junction of the first side and the second side with the contact surface and the front surface.

In such embodiments, the switch may also comprise a light source and a display panel that accepts and propagates lights from the light source.

In a specific embodiment of the present invention, the contact surface and/or the front surface of the housing form an undercut at a region near the first side and/or the second side.

The above and other objectives and advantages of the present invention can be more clearly illustrated by the following detailed description with reference to the drawings.

### BRIEF DESCRIPTION OF THE DRAWINGS

FIG. 1 shows the schematic diagram of an embodiment of the wearable device of the present invention.

FIG. 2 shows the circuit block diagram of an embodiment of the wearable device of the present invention.

FIG. 3 shows a schematic diagram of another embodiment of the wearable device of the present invention.

FIG. 4 shows the schematic diagram of an application example of the wearable device of the present invention.

FIG. 5 shows the schematic diagram of another application example of the wearable device of the present invention.

FIG. 6 shows the schematic diagram of a further application example of the wearable device of the present invention.

### DETAILED DESCRIPTION OF THE INVENTION

In the followings several embodiments of this invention will be given to illustrate the wearable device of the present invention. It is appreciated that these embodiments are used to exemplify the structure and applications of this invention. It is not intended to illustrate all possible embodiments of this invention. Scope of protection of the invention is defined by the attached claims, only.

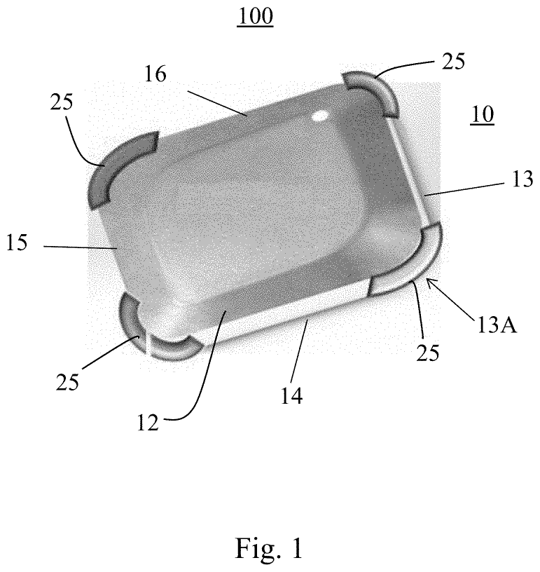

FIG. 1 is schematic diagram of an embodiment of the wearable device of the present invention. As shown in the figure, the invented wearable device 100 provides a housing 10 for accommodating electronic circuits and sensing components that are usually arranged on a circuit board. The housing 10 is usually formed in a square shape, but may be formed in other shapes. The preferred shape is a flat box shape, such as the aforementioned square box, or hexagonal box, triangular box, round box, oval box, or even a freeform box. There are no technical restrictions regarding the shape of the housing. However, if it is formed into a box shape, it may include two opposite surfaces, one of which cab be referred to as a contact surface 11, because it contacts the body of the wearer, while the opposite surface is referred to as a front surface 12. The contact surface 11 and the front surface 12 generally form a plane, and their shapes generally correspond. However, sometimes the front surface 12 may form a convex surface, and the contact surface 11 may form a concave surface.

A plurality of functions and function keys may be configured on the front surface 12, because the contact surface 11 will not be exposed when the wearable device 100 is worn. The functions provided on the front surface 12 of the wearable device may include a display screen, various control keys, and display signals. Of course, it may also include text and graphics. These functions, however, can only work when the user looks at it from the front. This has become a technical problem of all conventional wearable devices.

The contact surface 11 and the front surface 12 are kept at a certain distance from each other, and are connected by a first side 13. If necessary, there may also be a second side 14, a third side 15, a fourth side 16, and so on, to connect the contact surface 11 and the front surface 12. If there are multiple sides, the junction of two of the sides, such as the junction 13A of the first side 13 and the second side 14, will form an angle. If it is only a smooth connection, there is no need to separate into two sides.

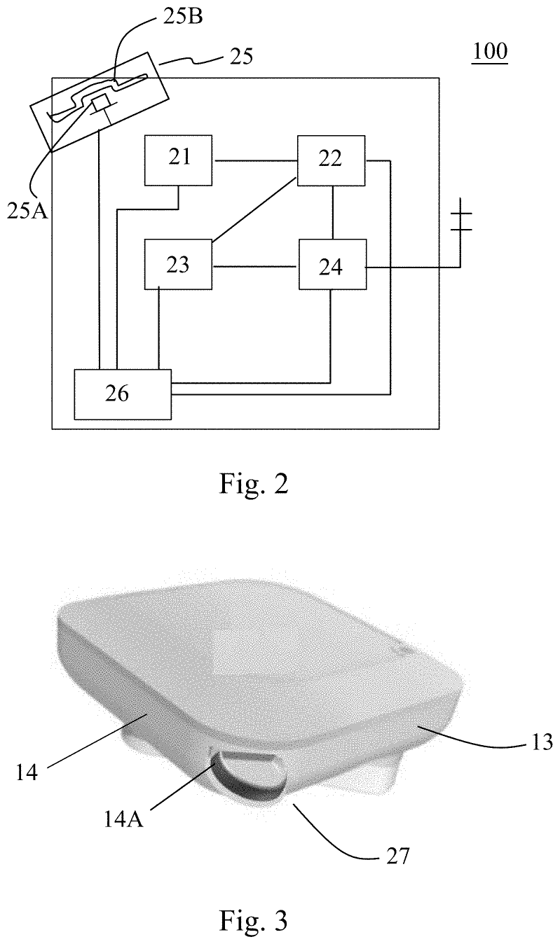

Generally speaking, a wearable device 100 uses a housing to accommodate various modules. The housing 10 includes a contact surface 11 and a front surface 12 opposite to the contact surface 11, and the two are connected by a first side 13. In a specific embodiment, the contact surface 11 and the front surface 12 are also connected by a second side 14. The junction 13A of the first side 13 and the second side 14 form an angle. The wearable device is a known object. It usually provides detection, calculation, communication and recording functions. Therefore, a wearable device usually includes a sensing device 21 and a processing device 22. FIG. 2 shows a circuit block diagram of an embodiment of the wearable device of the present invention. As shown in the figure, the wearable device 100 includes a sensing device 21 for sensing its own movements and outputting a sensing signal. Devices with this function include the various commercially available products in the market, such as a three-axis gyroscope, accelerometer, magnetometer and the like. This type of sensing device can detect the movement of the wearable device and output a sensing signals. The sensing signal is usually output in the form of voltage, while particular sensing devices would output digitized sensing values. The processing device 22 is in connection with the sensing device 21, for receiving the sensing signals of the sensing means 21 and converting them into sensing values. Generally speaking, the processing device 22 will include an analog-to-digital converter. It may also include other circuitry and software, for further processing of the sensing values.

The figure also shows that the wearable device 100 includes a memory device 23 and a communication device 24. The memory device 23 is used to store various parameters, programs, and sensing results and/or processing results. The communication device 24 is used to establish a communication channel with an external device (not shown) for exchange of data. The communication device 24 preferably provides at least one wired communication channel, such as a USB interface, Type C interface, and so on, and at least one wireless communication channel, such as the Bluetooth channel. A wearable device usually has the ability to establish a communication channel with a smartphone, so to provide sensing values to the application software of the phone. A wearable devices can also establish communication channels with a computer device, so to provide various sensing values to the computer devices. In addition, a general-purposed wearable devices can also receive commands from applications on smart phones and computer devices, so to provide sensing values in different forms or for different purposes. In other words, wearable devices can play different roles and provide different functions and uses, in response to applications executed in smart phones or computer devices.

The wearable device 100 also provides at least one signal indicator 25, which is arranged on the housing 10. A signal indicator 25 may include an indicator source 25A and a display board 25B. Indicators emitted from the indicator source 25A are directed toward the display panel 25B. The display panel 25B can receive the indicators emitted by the indicator source 25A and propagate the indicators. Therefore, when the indicator source 25A emits indicators, the display panel 25B will flash. A relatively simple signal indicator 25 may only include an indicator source covered with a light-transmitting material layer. The signal light 25 lights up when the light source emits light. The structure and function of the signal light are known. Detailed description thereof is thus omitted. A preferred example of the indicator source 25A is an LED.

The wearable device 100 further comprises a power supply device 26 to provide power for the sensing device 21, the processing device 22, the memory device 23, the communication device 24 and the signal indicator 25. The wearable device 100 cannot be connected to a stationary power source because it moves with the wearer, so it must be powered by a battery or solar cells. A power management circuit must also be used to extend the use time.

The power supply device 26, the sensing device 21, the processing device 22, the memory device 23, the communication device 24, and the signal indicator 25 are usually arranged on a single circuit board and accommodated in the housing 10. As mentioned previously, for the convenience of application, the housing 10 is usually flat box-shaped. But its shape is not any technical limitation.

As mentioned earlier, the functions of a general-purpose wearable device are not determined, until an application program executed in a computer device or a smartphone in communication with the wearable device is in operation. Therefore, it is impossible to predict which direction the front face of the wearable device faces in the wearing state.

According to the first embodiment of the present invention, the wearable device 100 comprises a housing 10 and at least one signal indicator 25. The display surface of the signal indicator 25 is disposed on the first side 13 and extends to a level at least flush with the contact surface 11 and/or the front surface 12.

Although it is not intended to limit the present invention by any theory, the inventor found that, when the wearable device is worn, the contact surface 11 would cover the body of the wearer and the front face 12 faces away from the body, therefore the user cannot see either of them. The first side 13 is the part facing the eyes of the user. The signal indicator 25 is arranged on the first side 1, with its display surface extending to a level flush with the contact surface 11 and/or the front surface 12, or even beyond the contact surface 11 and/or the front side 12, such that it projects from the contact surface 11 and/or the front surface 12. As a result thereof, the signal indicator 25 is visible to the user from multiple directions.

FIG. 1 also shows that the contact surface 11 (not shown in the figure) and/or the front surface 12 of the housing 10 forms an undercut 12A at regions close to the first side 13 and/or the second side 14. The undercut 12A allows the signal indicator 25 visible from more directions.

According to this invention, regardless of the orientation(s) that the application program operating in the smart phone or the computer in connection with the wearable device 100 requires, the signal indicator 25 is always visible to the user.

The signal indicator 25 can be configured in different shapes, different lengths, different colors, or a combination thereof, to represent different display contents. The displayed content can usually include power level, in operating, in recording, in connection, etc., which need to be displayed during wearing. Because the signal indicator 25 is provided on the first side 13, its shape is preferably elongated. There is no limit to the number of the signal indicator 25, as long as it can be arranged on the first side 13 so that the user can easily see it. A single signal indicator can also display multiple colors at the same time or at different times to represent different display contents.

In the second embodiment of the present invention, the contact surface 11 and the front surface 12 are connected by a first side 13 and a second side 14. The first side 13 and the second side 14 form an angle at their junction 13A. The signal light 25 is provided on the junction 13A where the first side 13 and the second side 14 are connected. This position is also the junction of the first side 13 and the second side 14 with the contact surface 11 and the front surface 12.

Arranging the signal indicator 25 at the junction of the four planes can make the signal indicator 25 visible from multiple directions.

FIG. 1 also shows that the wearable device 100 is provided with a signal indicator at the four four-plane junctions. And a single junction may have multiple signal indicators. However, in general applications, providing only one or multiple signal lights at a single junction would be sufficient for all applications.

According to the third embodiment of the present invention, the signal indicator 25 is also a switch button. The technology of make a signal indicator as a switch button is well known. For example, by extending the display panel of the signal indicator to actuate an electric switch, and providing a set of springs to support the display panel, the signal indicator can have the switch function.

According to the fourth embodiment of the present invention, the switch button is a push-push button (not shown in the figure). The push-push button is arranged on the first side 13, and when it raises, the top surface of the button is at a distance from the plane of the first side 13, allowing the user to see the top surface when viewing directing to the contacting surface 11 and/or the front surface 12. The push-push button can also be located at the junction of the first side 13 and the second side 14 with the contact surface 11 and the front surface 12. The push-push switch may also include an indicator source and a display panel that can receive and propagate indicators coming from the indicator source.

In the fifth embodiment of the present invention, the switch is a push-push button, but it does not have a signal light function. Such an embodiment is shown in FIG. 3. The push-push button 27 is disposed at the junction of the first side 13 and the second side 14 with the contact surface 11 and the front surface 12, all of the housing 10 of the wearable device 100. At this junction, the housing 10 provides an opening 14A, so that the push pin of the push-push button 27 can protrude from the opening. The push pin of the push-push button 27 changes between a raised position and a depressed position, which provides a non-light-emitting signaling function in addition to the control functions.

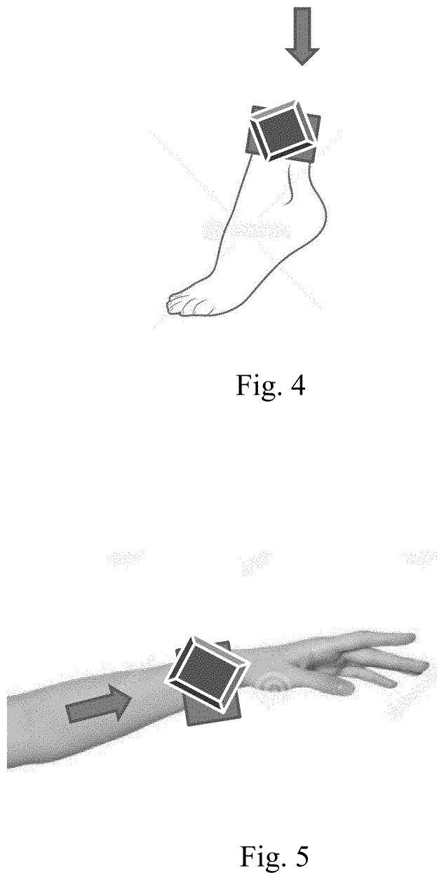

FIGS. 4 to 6 show schematic diagrams of three application examples of the wearable device of the present invention.

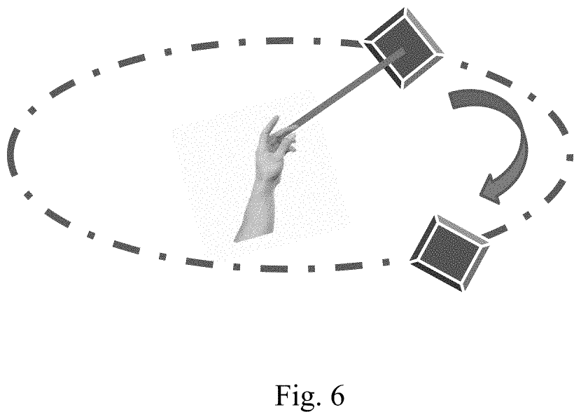

FIG. 4 shows an application example of the invented wearable device, when it is worn on the ankle of a user. FIG. 5 shows another application example of the invented wearable device being worn on a user's wrist. FIG. 6 shows a further application example, wherein the invented wearable device operates in a circular motion. The arrow in the figure indicates the user's visual direction. As shown in these figures, the user can easily see the signal indicator 25, especially the indicatoring/non indicatoring state of the signal indicator 25, regardless of the orientation which the application running on the smart phone or the computer device in connection with the wearable device 100 requires in wearing or using the wearable device 100.

The above is a description of the wearable device of the present invention according to various embodiments of the present invention. A skilled person in this industry can easily derive various changes and applications from the above description. However, these changes and applications are within the scope of protection of the present invention, which is solely defined by the attached claims.

What is claimed is:

1. A wearable device, comprising a housing, a sensing device and a processing device, wherein at least a part of the sensing device and/or the processing device is enclosed in the housing;
wherein the sensing device detects its own movement and outputs a sensing signal, and the processing device receives the sensing signal and converts the sensing signal into sensing values;
wherein the housing provides a contact surface and a front surface opposite to the contact surface and connected to the contact surface by a first side;
wherein the housing is provided at least one signal indicator, with a display surface disposed on the first side and extending to a level at least substantially flush with the contact surface and the front surface; and
wherein the wearable device further comprises a power device for supplying power to the sensing device, the processing device and the signal indicator.

2. The wearable device of claim 1, wherein the display surface extends beyond the contact surface and/or the front surface, and protrudes from the contact surface and/or the front surface.

3. The wearable device of claim 1, wherein the signal indicator comprises an indicator source and a display panel to receive and propagate indicators generated by the indicator source; wherein a display surface of the display panel is disposed on the first side and extending to a level at least substantially flush with the contact surface and the front surface.

4. The wearable device of claim 3, wherein the display surface of the display panel extends beyond the contact surface and/or the front surface, and protrudes from the contact surface and/or the front surface.

5. The wearable device of claim 1, wherein the contact surface and the front surface are connected by a first side and a second side, and the first side and the second side form an angle; and wherein the signal indicator is arranged at the junction of the first side and the second side.

6. The wearable device of claim 3, wherein the contact surface and the front surface are connected by a first side and a second side, and the first side and the second side form an angle; and wherein the signal indicator is arranged at the junction of the first side and the second side.

7. The wearable device of claim 1, wherein the contact surface and/or the front surface of the housing forms an undercut at a region close to the first side and/or the second side.

8. The wearable device of claim 3, wherein the contact surface and/or the front surface of the housing forms an undercut at a region close to the first side and/or the second side.

9. The wearable device of claim 1, wherein the signal indicator provides a switch function.

10. The wearable device of claim 3, wherein the signal indicator provides a switch function.

11. The wearable device of claim 1, wherein the signal light comprises a push-push button.

12. The wearable device of claim 3, wherein the signal light comprises a push-push button.

13. The wearable device of claim 1, wherein the sensing device, the processing device, the signal light and the power supply device are provided on a circuit board.

14. A wearable device, comprising a housing, a sensing device and a processing device, wherein at least a part of the sensing device and/or the processing device is enclosed in the housing;
wherein the sensing device detects its own movement and outputs a sensing signal, and the processing device receives the sensing signal and converts the sensing signal into sensing values;
wherein the housing provides a contact surface and a front surface opposite to the contact surface and connected to the contact surface by a first side;
wherein the housing is provided at least one push-push button, disposed on the first side and extending from the first side; and
wherein the wearable device further comprises a power device for supplying power to the sensing device and the processing device.

15. The wearable device of claim 14, wherein the contact surface and the front surface are connected by a first side and a second side, and the first side and the second side form an angle; and wherein the signal indicator is arranged at the junction of the first side and the second side.

16. The wearable device of claim 14, wherein the contact surface and/or the front surface of the housing forms an undercut at a region close to the first side and/or the second side.
